(19) United States
(12) Patent Application Publication
(10) Pub. No.: US 2026/0212036 A1
(43) Pub. Date: Jul. 23, 2026

(54) Methods and Systems for Concealing Secure Folder Contents and Notifications on Electronic Devices that are Shared Among Users

(71) Applicant: Motorola Mobility LLC, Chicago, IL (US)

(72) Inventors: Amit Kumar Agrawal, Bangalore (IN); Renuka Prasad Herur Rajashekaraiah, Bangalore (IN); Srikanth Raju, Bangalore (IN)

(21) Appl. No.: 19/030,347

(22) Filed: Jan. 17, 2025

(51) Int. Cl. G06F 21/62; G06F 21/55; G06F 21/60

(52) U.S. Cl. CPC G06F 21/6227; G06F 21/556; G06F 21/606

(57) ABSTRACT

A method in an electronic device involves determining, by one or more processors, that a secure folder has been enabled by a primary user and that at least one application has been stored in the secure folder. In response to a secondary user accessing the device, the method includes concealing the secure folder and precluding notifications generated by, or communications received by, the at least one application from being surfaced by the user interface. The method further includes concealing cross boundary data, application package kits, device settings, operational code, assets, resources, advertisements, and communications related to the applications in the secure folder. The system manages dual instances of applications for multiple users, ensuring the primary user's data remains secure and inaccessible to secondary users.

### BACKGROUND

### Technical Field

This disclosure relates generally to electronic devices, and more particularly to electronic devices offering containerized data storage.

### Background Art

As technology has advanced, computing devices, including compact computing devices such as smart phones and tablet computers, have become increasingly commonplace in daily life. Many individuals store large amounts of personal information and use these devices to access various service accounts. To prevent unauthorized access, devices often require a passcode or personal identification number (PIN) for unlocking. However, users frequently share their devices with others, such as family members. It would be advantageous to have improved systems and methods for securing personal information and service accounts of primary users of shared electronic devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device in accordance with one or more embodiments of the disclosure.

FIG. 3 illustrates another explanatory method in accordance with one or more embodiments of the disclosure.

FIG. 4 illustrates still another explanatory method in accordance with one or more embodiments of the disclosure.

FIG. 5 illustrates one or more method steps in accordance with one or more embodiments of the disclosure.

FIG. 6 illustrates one or more method steps in accordance with one or more embodiments of the disclosure.

FIG. 7 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, by one or more processors of an electronic device, that a secure folder has been enabled on the electronic device by a primary user, determining that at least one application has been stored in the secure folder by the primary user, and in response to a secondary user accessing the electronic device, both concealing, by the one or more processors, the secure folder and precluding notifications generated by, or communications received by, the at least one application from being surfaced by a user interface of the electronic device. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to, in response to a primary user having enabled a secure folder prior to a secondary user accessing the electronic device, conceal the secure folder and preclude notifications generated by, or communications received by, at least one application residing in the secure folder from being surfaced at the user interface of the electronic device while being used by the secondary user as described herein. The non-processor circuits may include, but are not limited to, a radio receiver, a radio transmitter, signal drivers, clock circuits, power source circuits, and user input devices.

As such, these functions may be interpreted as steps of a method to perform determining, by one or more processors of the electronic device, that a secure folder has been enabled on the electronic device by a primary user and determining, by the one or more processors, that at least one application or file has been added to the secure folder by the primary user. In one or more embodiments, the method comprises determining, by the one or more processors, the electronic device is being accessed by a non-primary user and, in response to determining that the electronic device is being accessed by a non-primary user, concealing, by the one or more processors, all contents and settings associated with the secure folder by making the contents and settings invisible and unsearchable on the electronic device, hiding, by the one or more processors, all notifications and advertisements corresponding to the at least one application or the file, and hiding, by the one or more processors, all transaction messages originating from or received by the at least one application or the file.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, users frequently share their devices with others, such as family members. For instance, a parent may allow a child to use the device to watch videos. Once the device is unlocked, the child may access the parent's personal information or service accounts. This situation compromises the security of personal information and service accounts, leading to potential frustration and privacy concerns.

Illustrating by example, some electronic devices allow for the establishment of “secure” folders to protect a user's most sensitive applications and media for added peace of mind. Such secure folders keep personal information hidden safely away. Most secure folders require a PIN for access. Some can even be disguised with fake names and icons to fool nefarious actors snooping for personal information.

Embodiments of the disclosure contemplate that these secure folders are not without their own issues, particularly when the device on which the secure folder is established is a shared device is accessible to family members by sharing the unlock code. First, any user with access to the device can easily determine if a secure folder has been set up and enabled, even though the folder and the folder's contents might not be accessible. This visibility can lead to unnecessary suspicions and privacy concerns.

Second, notifications relevant to applications added to the secure folder are still displayed outside the folder, potentially exposing sensitive information. Third, any application added to the secure folder remains searchable in the device's application list, even if the application was initially added outside the folder.

To illustrate these problems, consider a use case example: a primary user of a smartphone named Phil uses a secure folder to store his share market applications, aiming to keep these applications private and inaccessible to his family members. Phil's intention is to prevent discussions or disclosures about his share market activities, which he prefers to keep confidential. By adding these applications to the secure folder, Phil believes he has safeguarded their accessibility.

However, a significant issue arises when any family member who knows Phil's phone password can access the phone settings and easily determine that the secure folder feature has been enabled. This visibility of the secure folder, despite the contents being hidden, can lead to unnecessary suspicions about Phil's activities.

For instance, Phil's wife, upon noticing the enabled secure application found in the secure folder, might question the nature of the hidden contents, leading to potential misunderstandings and disputes. Moreover, the mere presence of the secure application in the phone settings can create an atmosphere of mistrust, as family members may speculate about the reasons for hiding certain applications. This situation exemplifies the need for a more robust solution that not only hides the contents within the secure folder but also conceals the existence of the secure folder itself from non-primary users.

Consider another example: Srikanth, an avid cricket enthusiast, frequently engages in betting activities during the Indian Premiere League (IPL) and World Cup seasons. Despite his family's disapproval, Srikanth continues to gamble, often losing significant amounts of money.

To keep his betting activities hidden, Srikanth utilizes the secure folder feature on his smartphone. By adding a popular cricket betting application to the secure folder, Srikanth aims to prevent his family from discovering his gambling habits.

Sadly, a significant issue arises when Srikanth's wife uses his phone to communicate with Srikanth's sister. During the call, a notification from the gambling application appears on the screen, stating, “Your balance is low, quickly add money” or “Create your team for the upcoming Ind-Pak match and get 10% bonus.”

This notification, despite the app being stored in the secure folder, becomes visible to Srikanth's wife. The exposure of such notifications not only reveals Srikanth's gambling activities but also leads to potential conflicts and mistrust within the family. This scenario underscores the need for a more robust solution that not only hides the contents within the secure folder but also conceals notifications and advertisements related to the applications stored in the secure folder.

Consider this additional example: Imagine a teenager named Sam, who, like many of his peers, is curious about dating and relationships. One day, Sam decides to download a dating application on his smartphone to explore and connect with others. Understanding the potential for parental disapproval, Sam takes the precaution of adding the dating app to the secure folder on his device. The secure folder is designed to protect sensitive applications and media, requiring a separate PIN for access and even allowing the folder to be disguised with a fake name and icon. Confident that his privacy is safeguarded, Sam begins using the application.

However, despite Sam's efforts to keep his activities private, a significant issue arises. The dating application, although stored in the secure folder, still appears in the device's application list outside the secure folder. This visibility poses a serious privacy concern for Sam, as his parents, who occasionally use his phone, can easily find the link to the dating application.

For instance, while using Sam's phone to check the weather or send a message, his parents might stumble upon the dating app in the settings or application list. This discovery could lead to uncomfortable questions, potential conflicts, and a breach of Sam's privacy. This scenario highlights the need for a more robust solution that not only hides the contents within the secure folder but also ensures that applications stored in the secure folder do not appear in the device's application list or settings.

These use cases demonstrate that sharing of electronic devices can lead to potential security risks and privacy concerns, as the personal information and service accounts of the primary user may become accessible to secondary users. Advantageously, the disclosed methods and systems aim to improve the security associated with the contents and settings of the secure folder.

In one or more embodiments a system determines if a secure folder has been enabled on the device by the primary owner and if at least one application or file has been added to the secure folder. In one or more embodiments, the system then determines if the device is being accessed by a primary user or a non-primary user, leveraging known methods such as utilizing the camera during the lock screen or detecting grip patterns.

In one or more embodiments, in response to the device being operated by a non-primary user, the system hides all contents (applications, files, notifications) and settings associated with the secure folder by making them invisible or non-searchable on the device. Additionally, the system can hide all notifications and advertisements relevant to applications added to the secure folder while the device is operated by a non-primary user, keeping them in a backlog and showing them only when the primary user returns to access the device.

In one or more embodiments, the system also hides all transaction messages originating from or received by the apps associated with the secure folder. Furthermore, the system manages dual instances of applications, ensuring that if only the application within the secure folder is being used, the application remains hidden and non-searchable when operated by a non-primary user in one or more embodiments.

In one or more embodiments, a method in an electronic device comprises determining, by one or more processors of the electronic device, that a secure folder has been enabled on the electronic device by a primary user. In one or more embodiments, the method further includes determining that at least one application has been stored in the secure folder by the primary user.

In one or more embodiments, in response to a secondary user accessing the electronic device, the method involves both concealing, by the one or more processors, the secure folder and precluding notifications generated by, or communications received by, the at least one application from being surfaced by a user interface of the electronic device. The determination that a secure folder has been enabled can involve the processors identifying the activation of the secure folder feature by the primary user. This may include verifying the secure folder's status through system settings or specific secure folder management applications.

In one or more embodiments, the determination that at least one application has been stored in the secure folder involves the processors scanning the secure folder to identify the presence of applications or files added by the primary user. In response to the secondary user accessing the electronic device, the processors can execute a series of actions to conceal the secure folder.

In one or more embodiments, this includes making the secure folder invisible or non-searchable within the device's user interface. Additionally, the processors may preclude any notifications generated by the applications within the secure folder from appearing on the user interface. This ensures that the secondary user cannot access or become aware of the contents and activities within the secure folder, thereby maintaining the privacy and security of the primary user's sensitive information.

Determining, by one or more processors of the electronic device, that a secure folder has been enabled on the electronic device by a primary user and determining that at least one application has been stored in the secure folder by the primary user, allows the system to identify the presence and contents of the secure folder. This enables the system to take appropriate actions to protect the secure folder's contents when a secondary user accesses the device.

In response to a secondary user accessing the electronic device, both concealing, by the one or more processors, the secure folder and precluding notifications generated by, or communications received by, the at least one application from being surfaced by a user interface of the electronic device ensures that sensitive information remains hidden from unauthorized users. This arrangement prevents secondary users from discovering the existence of the secure folder or accessing its contents, thereby maintaining the privacy and security of the primary user's data.

By making the secure folder and its contents invisible and non-searchable, the system effectively prevents any accidental or intentional exposure of sensitive information. This is particularly useful in scenarios where the device is shared among family members or other users, as it mitigates the risk of privacy breaches and potential conflicts arising from the discovery of hidden applications or files.

Additionally, precluding notifications and communications from being surfaced ensures that no inadvertent information leaks occur through pop-up messages or alerts, which could otherwise reveal the nature of the applications stored in the secure folder. This comprehensive approach to managing the visibility and accessibility of secure folder contents significantly enhances the overall security and user experience of the electronic device.

In one or more embodiments, a system determines if a secure folder has been enabled on the device by the primary owner and if at least one application or file has been added to the secure folder. The system then determines if the device is being accessed by a primary user or a non-primary user. In one or more embodiments, this determination leverages methods such as utilizing the camera during the lock screen or detecting grip patterns.

In response to the device being operated by a non-primary user, in one or more embodiments the system hides all contents (applications, files, notifications) and settings associated with the secure folder by making them invisible or non-searchable on the device. Additionally, the system can hide all notifications and advertisements relevant to applications added to the secure folder while the device is operated by a non-primary user, keeping them in a backlog and showing them only when the primary user returns to access the device.

In one or more embodiments, the system also hides all transaction messages originating from or received by the apps associated with the secure folder. Furthermore, the system can manage dual instances of applications, ensuring that if only the application within the secure folder is being used, the application remains hidden and non-searchable when operated by a non-primary user. This comprehensive approach advantageously ensures that sensitive information remains protected and inaccessible to unauthorized users, thereby maintaining the privacy and security of the primary user's data.

In one or more embodiments, an electronic device configured in accordance with embodiments of the disclosure comprises a user interface, a communication device, and one or more processors operable with the user interface and the communication device. In one or more embodiments, the one or more processors are configured to, in response to a primary user having enabled a secure folder prior to a secondary user accessing the electronic device, conceal the secure folder and preclude notifications generated by, or communications received by, at least one application residing in the secure folder from being surfaced at the user interface of the electronic device while being used by the secondary user.

In one or more embodiments, the one or more processors are further configured to hide all transaction messages originating from or received by the at least one application residing in the secure folder. The one or more processors can further be configured to manage dual instances of the at least one application when the secondary user has a user account at the at least one application, with at least one instance of the at least one application being hidden and unsearchable by the secondary user.

In one or more embodiments, the electronic device further comprises one or more sensors. In one or more embodiments, the one or more processors are further configured to, in response to the one or more sensors detecting an authorized user of the electronic device holding the electronic device, reveal the secure folder on the user interface.

Advantageously, this arrangement ensures that sensitive information within the secure folder remains hidden from unauthorized users, thereby maintaining the privacy and security of the primary user's data. By concealing the secure folder and precluding notifications and communications from being displayed, the system prevents secondary users from discovering the existence of the secure folder or accessing its contents. This is particularly useful in scenarios where the device is shared among family members or other users, as it mitigates the risk of privacy breaches and potential conflicts arising from the discovery of hidden applications or files. Additionally, this approach enhances the overall user experience by ensuring that sensitive information is not inadvertently exposed through pop-up messages or alerts.

In one or more embodiments, a method in an electronic device comprises determining, by one or more processors of the electronic device, that a secure folder has been enabled on the electronic device by a primary user. In one or more embodiments, the method further includes determining, by the one or more processors, that at least one application or file has been added to the secure folder by the primary user.

In one or more embodiments, the method also involves determining, by the one or more processors, that the electronic device is being accessed by a non-primary user. In response to determining that the electronic device is being accessed by a non-primary user, the method can include concealing, by the one or more processors, all contents and settings associated with the secure folder by making the contents and settings invisible and unsearchable on the electronic device. Additionally, the method can involve hiding, by the one or more processors, all notifications and advertisements corresponding to the at least one application or the file. Furthermore, the method can include hiding, by the one or more processors, all transaction messages originating from or received by the at least one application or the file.

Advantageously, this arrangement of method steps ensures that sensitive information within the secure folder remains hidden from unauthorized users, thereby maintaining the privacy and security of the primary user's data. By concealing the secure folder and precluding notifications and communications from being displayed, the system prevents secondary users from discovering the existence of the secure folder or accessing its contents. This is particularly useful in scenarios where the device is shared among family members or other users, as it mitigates the risk of privacy breaches and potential conflicts arising from the discovery of hidden applications or files. Additionally, this approach enhances the overall user experience by ensuring that sensitive information is not inadvertently exposed through pop-up messages or alerts.

The method also includes managing dual instances of applications when the secondary user is a registered user of the application, ensuring that the application remains hidden and non-searchable when operated by a non-primary user. This comprehensive approach advantageously ensures that sensitive information remains protected and inaccessible to unauthorized users, thereby maintaining the privacy and security of the primary user's data. Other advantages will be described below. Still others will be obvious to those of ordinary skill in the art having the benefit of this disclosure.

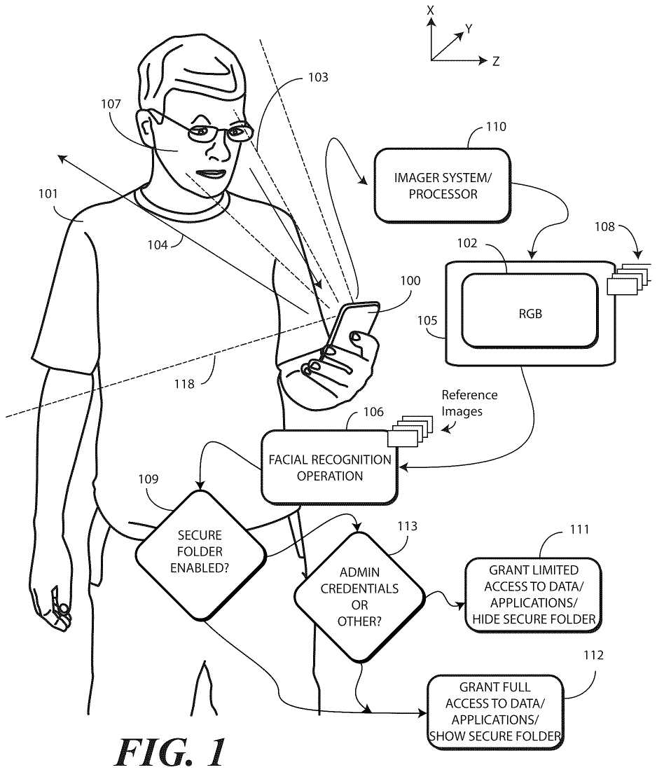

Turning now to FIG. 1, illustrated therein is one explanatory electronic device 100 configured in accordance with one or more embodiments of the disclosure. Also shown in FIG. 1 are one or more method steps for the electronic device 100.

In FIG. 1, a user 101 is authenticating himself as a primary user of the electronic device 100 to gain limited operational access to features, services, applications, data, content, or other properties of the electronic device 100 in accordance with one or more embodiments of the disclosure. In this illustrative embodiment, the authentication process is “touchless” in that the user 101 need not manipulate or interact with the electronic device 100 using his fingers. To the contrary, in accordance with one or more embodiments of the disclosure, the user is authenticated using an imaging process where images of the user 101 are captured by an imager. When this occurs, one or more processors of the electronic device 100 can grant operational access to the electronic device 100.

Illustrating by example, when the user 101 of the electronic device 100 is authenticated as a primary user of the electronic device and a secure folder is enabled, the one or more processors of the electronic device 100 will grant access to the secure folder. This access allows the primary user to interact with the contents of the secure folder, including applications, files, and any associated settings. The primary user can then view, modify, and manage the secure folder's contents without any restrictions, ensuring that all personal and sensitive information remains accessible to the primary user.

If the user 101 is authenticated as a non-primary user of the electronic device 100, the one or more processors of the electronic device 100 will both conceal the secure folder and preclude notifications generated by, or communications received by, at least one application stored in the secure folder from being surfaced by a user interface of the electronic device in one or more embodiments. This concealment can involve making the secure folder and the secure folder's contents invisible and non-searchable within the device's user interface.

Additionally, the processors can ensure that any notifications or communications related to the applications within the secure folder do not appear on the user interface, thereby maintaining the privacy and security of the primary user's sensitive information. This arrangement advantageously prevents non-primary users from discovering the existence of the secure folder or accessing the secure folder's contents, thereby safeguarding the primary user's data from unauthorized access.

In this illustrative embodiment, an imager 102 captures at least one image 103 of an object situated within a predefined radius 104 of the electronic device 100, which in this case is the face 107 of the user 101. In one embodiment, the imager 102 captures a single image 103 of the object. In another embodiment, the imager 102 captures a plurality of images 103,118 of the object. In one or more embodiments, the plurality of images 103,118 can be stored in a circular buffer situated within a memory of the electronic device 100. As more recent images of the plurality of images 103,118 are captured and added to the circular buffer, they replace less recent images of the plurality of images in the circular buffer at step 105 in one or more embodiments.

In one or more embodiments, the one or more images 103 are each a two-dimensional image. For example, in one embodiment the image 103 is a two-dimensional RGB image. In another embodiment, the image 103 is a two-dimensional infrared image. Other types of two-dimensional images will be obvious to those of ordinary skill in the art having the benefit of this disclosure.

In one or more embodiments, the image 103 can be compared to one or more predefined reference images 108. By making such a comparison, one or more processors 110 can confirm whether the shape, skin tone, eye color, hair color, hair length, and other features identifiable in a two-dimensional image are that of the authorized user identified by the one or more predefined reference images 108.

In one or more embodiments, the image 103 and/or the plurality of images 103,118 are used for authentication purposes at step 106. Illustrating by example, in one or more embodiments step 106 includes one or more processors 110 comparing the image 103 with the one or more predefined reference images 108. The authentication of step 106 will fail in one or more embodiments unless the image 103 sufficiently corresponds to at least one of the one or more predefined reference images 108.

As used herein, “sufficiently” means within a predefined threshold. For example, if one of the predefined reference images 108 includes five hundred reference features, such as facial shape, nose shape, eye color, background image, hair color, skin color, and so forth, the image 103 will sufficiently correspond to at least one of the one or more predefined reference images 108 when a certain number of features in the image 103 are also present in the predefined reference images 108. This number can be set to correspond to the level of security desired. Some users may want ninety percent of the reference features to match, while other users will be content if only eighty percent of the reference features match, and so forth.

Where the authentication of step 106 is successful in authenticating the user 101 as a primary or secondary (non-primary_user of the electronic device 100, i.e., where the at least one image 103 sufficiently corresponds to at least one of the one or more predefined reference images 108, the method can move to decision 109. Otherwise, if no authentication occurs, the electronic device 100 can lock.

In decision 109 of FIG. 1, the one or more processors 110 of the electronic device 100 determine whether a secure folder has been enabled on the electronic device. In one or more embodiments, decision 109 also determines that at least one application has been stored within the secure folder by a primary user. This determination can be achieved through multiple methods.

One method involves the processors 110 querying the system settings of the electronic device 100 to check for the activation status of the secure folder feature. This method leverages the existing system configuration data, providing a straightforward and efficient way to ascertain the secure folder's status without requiring additional resources.

Another method involves the processors 110 scanning for the presence of specific secure folder management applications or services running on the electronic device. By identifying these applications or services, the processors can confirm the secure folder's activation. This method benefits from being able to detect the secure folder's status even if the system settings are not directly accessible or have been obfuscated.

A third method utilizes the processors 110 to monitor user interactions and system logs for activities indicative of secure folder usage, such as the creation of secure folder directories or the movement of files into the secure folder. This method provides a dynamic and real-time approach to determining the secure folder's status, ensuring that any changes in the secure folder's activation are promptly detected.

Each of these methods offers distinct advantages. Querying system settings is efficient and resource-light, making querying system settings suitable for quick checks. Scanning for management applications or services provides a robust way to detect the secure folder's status even in more secure or obfuscated environments. Monitoring user interactions and system logs offers real-time detection, ensuring that the system remains up to date with the secure folder's status. By employing these methods, the electronic device can reliably determine whether a secure folder has been enabled, thereby enhancing the overall security and user experience.

In one or more embodiments, at decision 113 of FIG. 1 the one or more processors 110 of the electronic device 100 determine whether a user of the electronic device 100 is a primary user or a non-primary user. This determination can be achieved through multiple methods, each leveraging different technologies and data sources to ascertain the user's identity and role.

One method involves utilizing the camera during the lock screen to capture an image of the user. The processors 110 then compare this image to predefined reference images stored in the device's memory. By analyzing facial features, skin tone, eye color, and other biometric data, the processors can confirm whether the user matches the primary user's profile. This method benefits from high accuracy and security, as the method relies on biometric identifiers that are difficult to replicate.

Another method involves detecting grip patterns using sensors embedded in the device. The processors 110 analyze the way the user holds and interacts with the device, comparing these patterns to those previously recorded for the primary user. Grip pattern recognition provides a non-intrusive and continuous authentication mechanism, allowing the device to seamlessly differentiate between users without requiring active input from the user. This method is advantageous for the unobtrusiveness and ability to operate in the background, ensuring a smooth user experience.

A third method leverages behavioral analysis, where the processors 110 monitor the user's interaction with the device over time. This includes analyzing typing speed, touch pressure, and navigation habits. By building a behavioral profile of the primary user, the device can detect deviations that may indicate a non-primary user is operating the device. Behavioral analysis offers the advantage of adaptability, as the system continuously learns and updates the user's profile, enhancing the system's ability to detect unauthorized access. Each of these methods provides distinct advantages.

Facial recognition offers high security through biometric verification, grip pattern recognition ensures a seamless and non-intrusive user experience, and behavioral analysis provides continuous and adaptive authentication. By employing a combination of these methods, the electronic device 100 can robustly determine whether the user is a primary or non-primary user, thereby enhancing the overall security and usability of the device.

When decision 109 determines that a secure folder has been enabled on the electronic device 100 by a primary user that at least one application has been stored in the secure folder by the primary user, such as through querying system settings, scanning for secure folder management applications, or monitoring user interactions and system logs, and where decision 113 determines a secondary user accessing the electronic device 100, step 111 can include both concealing, by the one or more processors, the secure folder and precluding notifications generated by, or communications received by, the at least one application from being surfaced by a user interface of the electronic device 100.

In one or more embodiments, concealing the secure folder at step 111 involves making the secure folder invisible or non-searchable within the device's user interface. Precluding notifications at step 111 ensures that no alerts or messages related to the applications within the secure folder appear on the user interface, thereby maintaining the privacy and security of the primary user's sensitive information.

In one or more embodiments, step 111 also includes concealing, by the one or more processors, cross-boundary data spilling from the secure folder into public access application package kit data of the electronic device. This advantageously ensures that any residual data from applications moved to the secure folder does not remain accessible outside the secure folder.

Additionally, in one or more embodiments step 111 involves concealing an application package kit associated with the at least one application, which includes data required to install and run the application. This step 111 ensures that the application package kit remains hidden and inaccessible to secondary users.

Further, step 111 can include concealing all device settings associated with the at least one application in response to the secondary user accessing the electronic device. This ensures that any settings related to the applications within the secure folder are not visible or modifiable by secondary users.

Step 111 can also involve concealing operational code, assets, and resources associated with the at least one application, ensuring that all components of the application remain hidden. The action can include concealing advertisements received by a communication device of the electronic device that are related to the at least one application. This prevents any ads related to the applications within the secure folder from being displayed to secondary users. The communications concealed at step 111 can include short message service (SMS) communications, ensuring that any messages related to the applications within the secure folder remain hidden.

In one or more embodiments, step 111 involves precluding visibility of the secure folder at the user interface of the electronic device, ensuring that secondary users cannot see or access the secure folder. When the at least one application is configured for use by multiple users, step 111 can include maintaining dual instances of the application. In one or more embodiments, this involves creating a first instance of the application utilizing first data associated with the secondary user and omitting usage of second data associated with the primary user, and a second instance of the application utilizing both the first data and the second data. Advantageously, this ensures that the application remains functional for secondary users without exposing the primary user's data.

Accordingly, in one or more embodiments step 111 grants only limited operational access to features, applications, data, services, or other benefits of the electronic device 100. For example, with the limited operational access, the user 101 may be able to access non-personal data, such as by browsing the Internet, and may be able to access applications that do not include personal data, such as games. However, with the limited operational access the user 101 may not be able to see pictures stored on the electronic device 100, electronic mail, messages, and other information stored in the secure folder enabled on the electronic device 100. Additionally, the user 101 may not be able to access health or financial applications or data operating on or stored in the secure folder enabled on electronic device 100.

Where decision 113 determines that the user 101 is a primary user of the electronic device 100, step 112 can comprise, granting, by the one or more processors 110 of the electronic device 100, full operational access to the features, the applications, or the data of the electronic device 100, including those applications stored in the secure folder.

In one or more embodiments, when the facial recognition occurring at step 106 fails, for whatever reason, the one or more processors 110 can lock the electronic device 100. Alternatively, the one or more processors 110 can or limit access the electronic device 100 in accordance with the initial, limited operational access to preclude access to certain applications or sensitive or personal information stored therein. When the electronic device 100 is locked, the one or more processors 110 may then require additional authentication inputs or factors, such as prompting the user 101 to type, speak or look into imager, or may require the user 101 to express a predefined mien that substantially matches the predefined authentication references to authenticate the user 101 at the next authentication cycle. Other security measures will be obvious to those of ordinary skill in the art having the benefit of this disclosure.

Accordingly, the method steps shown in FIG. 1 set forth a method where one or more processors determine that a secure folder has been enabled on the electronic device by a primary user. The method further includes determining, by the one or more processors, that at least one application or file has been added to the secure folder by the primary user.

In one or more embodiments, the method also involves determining, by the one or more processors, that the electronic device is being accessed by a non-primary user. In response to determining that the electronic device is being accessed by a non-primary user, the method includes concealing, by the one or more processors, all contents and settings associated with the secure folder by making the contents and settings invisible and unsearchable on the electronic device.

Additionally, the method can involves hiding, by the one or more processors, all notifications and advertisements corresponding to the at least one application or the file, and hiding, by the one or more processors, all transaction messages originating from or received by the at least one application or the file. In one or more embodiments, the at least one application or the file comprises the at least one application, further comprising managing, by the one or more processors, dual instances of the at least one application when the secondary user is a registered user of the at least one application.

In one or more embodiments, the method further includes hiding, by the one or more processors, all device settings associated with the at least one application in response to the secondary user accessing the electronic device. Additionally, the method can involve concealing, by the one or more processors, cross-boundary data spilling from the secure folder into public access application package kit data of the electronic device. In some embodiments, the method also includes storing, by the one or more processors, notifications and advertisements corresponding to the at least one application or the file in the secure folder and precluding access to the notifications and advertisements corresponding to the at least one application or the file until the primary user is detected accessing the electronic device.

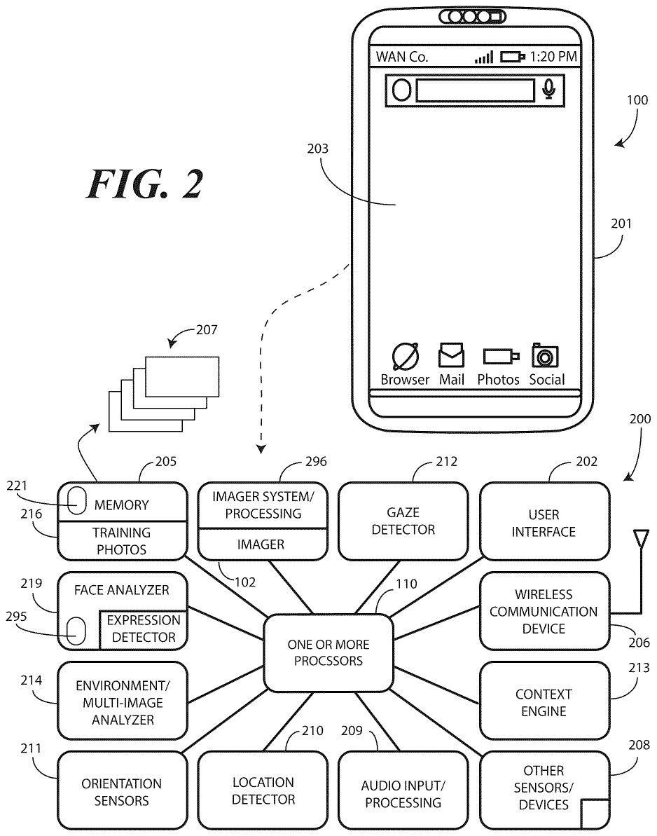

Turning now to FIG. 2, illustrated therein is one explanatory block diagram schematic 200 of one explanatory electronic device 100 configured in accordance with one or more embodiments of the disclosure. The electronic device 100 can be one of various types of devices.

In one embodiment, the electronic device 100 is a portable electronic device, one example of which is a smartphone that will be used in the figures for illustrative purposes. However, it should be obvious to those of ordinary skill in the art having the benefit of this disclosure that the block diagram schematic 200 could be used with other devices as well, including conventional desktop computers, palm-top computers, tablet computers, gaming devices, media players, wearable devices, or other devices. Still other devices will be obvious to those of ordinary skill in the art having the benefit of this disclosure.

In one or more embodiments, the block diagram schematic 200 is configured as a printed circuit board assembly disposed within a housing 201 of the electronic device 100. Various components can be electrically coupled together by conductors or a bus disposed along one or more printed circuit boards.

The illustrative block diagram schematic 200 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

The illustrative block diagram schematic 200 includes a user interface 202. In one or more embodiments, the user interface 202 includes a display 203, which may optionally be touch sensitive. In one embodiment, users can deliver user input to the display 203 of such an embodiment by delivering touch input from a finger, stylus, or other objects disposed proximately with the display 203. In one embodiment, the display 203 is configured as an active matrix organic light emitting diode (AMOLED) display. However, it should be noted that other types of displays, including liquid crystal displays, suitable for use with the user interface 202 would be obvious to those of ordinary skill in the art having the benefit of this disclosure.

In one embodiment, the electronic device includes one or more processors 110. In one embodiment, the one or more processors 110 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 200. Each of the application processor and the auxiliary processor(s) can be configured to process and execute executable software code to perform the various functions of the electronic device with which the block diagram schematic 200 operates.

A storage device, such as memory 205, can optionally store the executable software code used by the one or more processors 110 during operation. In one or more embodiments, a primary user of the electronic device 100 can enable a secure folder 221 in the memory 205. In one or more embodiments, the primary user can store applications in the secure folder 221, thereby transforming them into secure applications.

In this illustrative embodiment, the block diagram schematic 200 also includes a communication circuit 206 that can be configured for wired or wireless communication with one or more other devices or networks. The networks can include a wide area network, a local area network, and/or personal area network. The communication circuit 206 may also utilize wireless technology for communication, such as, but are not limited to, peer-to-peer or ad hoc communications such as HomeRF, Bluetooth and IEEE 802.11; and other forms of wireless communication such as infrared technology. The communication circuit 206 can include wireless communication circuitry, one of a receiver, a transmitter, or transceiver, and one or more antennas.

In one embodiment, the one or more processors 110 can be responsible for performing the primary functions of the electronic device with which the block diagram schematic 200 is operational. For example, in one embodiment the one or more processors 110 comprise one or more circuits operable with the user interface 202 to present presentation information to a user. The executable software code used by the one or more processors 110 can be configured as one or more modules 207 that are operable with the one or more processors 110. Such modules 207 can store instructions, control algorithms, and so forth.

Illustrating by example, in one or more embodiments the one or more processors 110 are configured to, in response to a primary user having enabled a secure folder 221 prior to a secondary user accessing the electronic device 100, conceal the secure folder 221 and preclude notifications generated by, or communications received by, at least one application residing in the secure folder 221 from being surfaced at the user interface 202 of the electronic device 100 while being used by the secondary user. The one or more processors 110 can further be configured to hide all transaction messages originating from or received by the at least one application residing in the secure folder 221.

In some embodiments, the one or more processors 110 are also configured to manage dual instances of the at least one application when the secondary user has a user account at the at least one application, with at least one instance of the at least one application being hidden and unsearchable by the secondary user.

In one or more embodiments, the electronic device 100 comprises one or more sensors 208. In one or more embodiments, the one or more processors 110 are further configured to, in response to the one or more sensors 208 detecting an authorized user of the electronic device 100 holding the electronic device 100, reveal the secure folder 221 on the user interface 202.

In one or more embodiments, the block diagram schematic 200 includes an audio input/processor 209. The audio input/processor 209 can include hardware, executable code, and speech monitor executable code in one embodiment. The audio input/processor 209 can include, stored in memory 205, basic speech models, trained speech models, or other modules that are used by the audio input/processor 209 to receive and identify voice commands that are received with audio input captured by an audio capture device.

In one embodiment, the audio input/processor 209 can include a voice recognition engine. Regardless of the specific implementation utilized in the various embodiments, the audio input/processor 209 can access various speech models to identify speech commands.

Various sensors 208 can be operable with the one or more processors 110. FIG. 2 illustrates several examples such sensors. It should be noted that those shown in FIG. 2 are not comprehensive, as others will be obvious to those of ordinary skill in the art having the benefit of this disclosure. Additionally, it should be noted that the various sensors shown in FIG. 2 could be used alone or in combination. Accordingly, many electronic devices will employ only subsets of the sensors shown in FIG. 2, with the particular subset defined by device application.

A first example of a sensor that can be included is a touch sensor. The touch sensor can include a capacitive touch sensor, an infrared touch sensor, resistive touch sensors, or another touch-sensitive technology.

Another example of a sensor is a geo-locator that serves as a location detector 210. In one embodiment, location detector 210 is able to determine location data when the touchless authentication process occurs by capturing the location data from a constellation of one or more earth orbiting satellites, or from a network of terrestrial base stations to determine an approximate location. The location detector 210 may also be able to determine location by locating or triangulating terrestrial base stations of a traditional cellular network, or from other local area networks, such as Wi-Fi networks.

One or more motion detectors can be configured as an orientation detector 211 that determines an orientation and/or movement of the electronic device 100 in three-dimensional space. Illustrating by example, the orientation detector 211 can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The orientation detector 211 can determine the spatial orientation of an electronic device 100 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 100.

A gaze detector 212 can comprise sensors for detecting the user's gaze point. The gaze detector 212 can optionally include sensors for detecting the alignment of a user's head in three-dimensional space. Electronic signals can then be processed for computing the direction of user's gaze in three-dimensional space. The gaze detector 212 can further be configured to detect a gaze cone corresponding to the detected gaze direction, which is a field of view within which the user may easily see without diverting their eyes or head from the detected gaze direction. The gaze detector 212 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 212 of FIG. 2.

Other components operable with the one or more processors 110 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The one or more sensors 208 can also include proximity sensors. The proximity sensors fall into one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 201 of the electronic device 100. In one embodiment, the signal receiver is an infrared signal receiver to receive an infrared emission from an object such as a human being when the human is proximately located with the electronic device 100.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 110 can cause each proximity sensor component to operate at a first “effective” sensitivity so as to receive infrared emissions from a first distance. Similarly, the one or more processors 110 can cause each proximity sensor component to operate at a second sensitivity, which is less than the first sensitivity, so as to receive infrared emissions from a second distance, which is less than the first distance. The sensitivity change can be effected by causing the one or more processors 110 to interpret readings from the proximity sensor component differently.

By contrast, proximity detector components include a signal emitter and a corresponding signal receiver. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which are one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The one or more sensors 208 can optionally include a barometer operable to sense changes in air pressure due to elevation changes or differing pressures of the electronic device 100. The one or more sensors 208 can also optionally include a light sensor that detects changes in optical intensity, color, light, or shadow in the environment of an electronic device. Similarly, a temperature sensor can be configured to monitor temperature about an electronic device.

A context engine 213 can then be operable with the various sensors 208 to detect, infer, capture, and otherwise determine persons and actions that are occurring in an environment about the electronic device 100. For example, where included one embodiment of the context engine 213 determines assessed contexts and frameworks using adjustable algorithms of context assessment employing information, data, and events. These assessments may be learned through repetitive data analysis. Alternatively, a user may employ the user interface 202 to enter various parameters, constructs, rules, and/or paradigms that instruct or otherwise guide the context engine 213 in detecting multi-modal social cues, emotional states, moods, and other contextual information. The context engine 213 can comprise an artificial neural network or other similar technology in one or more embodiments.

In one or more embodiments, the context engine 213 is operable with the one or more processors 110. In some embodiments, the one or more processors 110 can control the context engine 213. In other embodiments, the context engine 213 can operate independently, delivering information gleaned from detecting multi-modal social cues, emotional states, moods, and other contextual information to the one or more processors 110. The context engine 213 can receive data from the various sensors. In one or more embodiments, the one or more processors 110 are configured to perform the operations of the context engine 213.

An authentication system 296 can be operable with an imager 102. In one embodiment, the imager 102 comprises a two-dimensional imager configured to receive at least one image of a person within an environment of the electronic device 100. In one embodiment, the imager 102 comprises a two-dimensional RGB imager. In another embodiment, the imager 102 comprises an infrared imager. Other types of imagers suitable for use as the imager 102 of the authentication system 296 will be obvious to those of ordinary skill in the art having the benefit of this disclosure.

The authentication system 296 can be operable with a face analyzer 219 and an environmental analyzer 214. The face analyzer 219 and/or environmental analyzer 214 can be configured to process an image of an object and determine whether the object matches predetermined criteria. For example, the face analyzer 219 and/or environmental analyzer 214 can operate as an identification module configured with optical and/or spatial recognition to identify objects using image recognition, character recognition, visual recognition, facial recognition, color recognition, shape recognition, and the like. Advantageously, the face analyzer 219 and/or environmental analyzer 214, operating in tandem with the authentication system 296, can be used as a facial recognition device to determine the identity of one or more persons detected about the electronic device 100.

Illustrating by example, in one embodiment when the authentication system 296 detects a person, the imager 102 can capture a photograph of that person. The authentication system 296 can then compare the image to one or more predefined authentication reference files stored in the memory 205. This comparison, in one or more embodiments, is used to confirm beyond a threshold authenticity probability that the person's face in the image sufficiently matches one or more of the reference files.

Beneficially, this optical recognition performed by the authentication system 296 operating in conjunction with the face analyzer 219 and/or environmental analyzer 214 allows access to the electronic device 100 only when one of the persons detected about the electronic device are sufficiently identified as the owner of the electronic device 100.

Accordingly, in one or more embodiments the one or more processors 110, working with the authentication system 296 and the face analyzer 219 and/or environmental analyzer 214, can determine whether at least one image captured by the imager 102 matches one or more predefined criteria. In one or more embodiments, where they do, the one or more processors 110 determine whether the authenticated user is a primary or non-primary of the electronic device of the electronic device 100.

In one or more embodiments, a user can “train” the electronic device 100 for additional security by storing predefined miens 295 in the face analyzer 219 or reference photos 216 depicting the predefined miens in the memory 205 of the electronic device 100 that must be expressed for primary user status to be granted. Illustrating by example, a user may take a series of pictures. These can include specifically articulated miens. They can include the user raising a hand or looking in one direction, such as in a profile view. The miens can include raised eyebrows or one eye closed or an open mouth or a finger touching the chin. These are merely examples of items that can be stored in the reference images. Others will be readily obvious to those of ordinary skill in the art having the benefit of this disclosure. Any of these can constitute the fourth criterion from the preceding paragraph.

It is contemplated that in some situations, facial recognition or mien detection can fail. In one or more embodiments, when this occurs, the one or more processors 110 prompt, on the user interface 202, for one or more of a personal identification number or password.

Authentication, using facial recognition, and advanced feature, data, or application access, using mien detection, can occur in series, with more and more operational access to the features being granted as the required number of miens are expressed. Thus, in one or more embodiments the authentication system 296 or one or more processors 110 are able to detect the mien while the limited operational access is granted. Thereafter, the one or more processors 110 can grant full operational access to the features, applications, or data of the electronic device 100 when the necessary mien or miens is/are expressed.

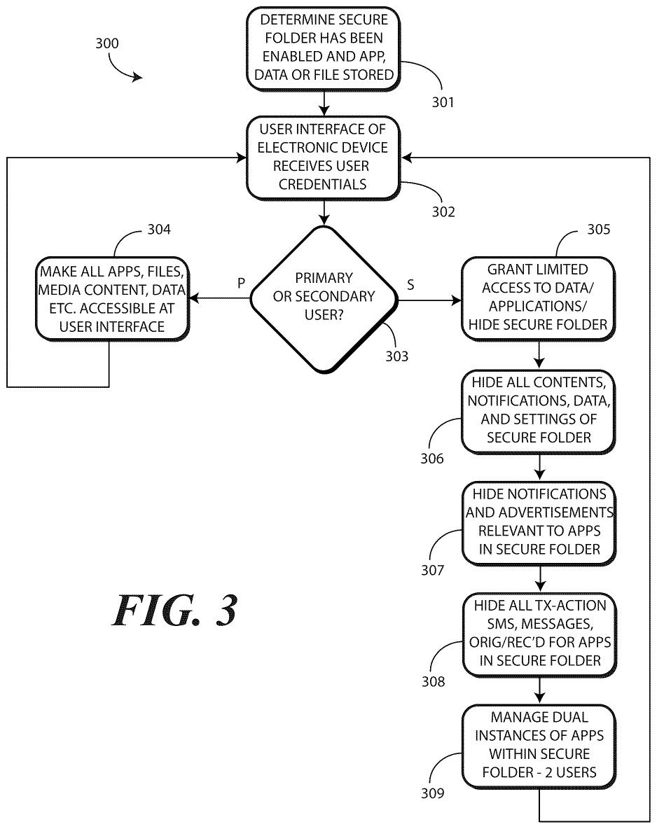

Turning now to FIG. 3, illustrated therein is one explanatory method in accordance with one or more embodiments of the disclosure. In one or more embodiments, step 301 comprises determining, by one or more processors of the electronic device, that a secure folder has been enabled on the electronic device by a primary user. In one or more embodiments, step 301 further comprises determining, by the one or more processors, that at least one application or file has been added to the secure folder by the primary user.

In one or more embodiments, step 302 of FIG. 3 determines that an electronic device is being accessed by a user. Step 302 can occur using multiple methods, each leveraging different technologies and data sources to ascertain the user's identity and role.

Illustrating by example, one method involves utilizing the camera during the lock screen to capture an image of the user. The processors then compare this image to predefined reference images stored in the device's memory. By analyzing facial features, skin tone, eye color, and other biometric data, the processors confirm whether the user matches the primary user's profile. This method benefits from high accuracy and security, as the method relies on biometric identifiers that are difficult to replicate.

Another method involves detecting grip patterns using sensors embedded in the device. The processors analyze the way the user holds and interacts with the device, comparing these patterns to those previously recorded for the primary user. Grip pattern recognition provides a non-intrusive and continuous authentication mechanism, allowing the device to seamlessly differentiate between users without requiring active input from the user. This method is advantageous for the unobtrusiveness and ability to operate in the background, ensuring a smooth user experience.

A third method leverages behavioral analysis, where the processors monitor the user's interaction with the device over time. This includes analyzing typing speed, touch pressure, and navigation habits. By building a behavioral profile of the primary user, the device can detect deviations that may indicate a non-primary user is operating the device. Behavioral analysis offers the advantage of adaptability, as the system continuously learns and updates the user's profile, enhancing the system's ability to detect unauthorized access. Each of these methods provides distinct advantages.

Facial recognition offers high security through biometric verification, grip pattern recognition ensures a seamless and non-intrusive user experience, and behavioral analysis provides continuous and adaptive authentication. By employing a combination of these methods, the electronic device can robustly determine whether the user is a primary or non-primary user, thereby enhancing the overall security and usability of the device.

Decision 303 then determines, from the data received at step 302, whether the electronic device is being accessed by a primary or non-primary user of the electronic device. Where the user accessing the electronic device is a primary user, step 304 reveals the secure folder and opens access to the electronic device. Where the user accessing the electronic device is a non-primary user, the method 300 moves to step 305.

In one or more embodiments, step 305 comprises concealing, by the one or more processors, all contents and settings associated with the secure folder by making the contents and settings invisible and unsearchable on the electronic device. In one or more embodiments, step 305 further comprises concealing, by the one or more processors, cross boundary data spilling from the secure folder into public access application package kit data of the electronic device.

In one or more embodiments, optional step 306 comprises hiding, by the one or more processors, all notifications and advertisements corresponding to the at least one application or the file. In one or more embodiments, step 306 comprises further hiding, by the one or more processors, all device settings associated with the at least one application in response to the secondary user accessing the electronic device.

In one or more embodiments, optional step 307 comprises storing, by the one or more processors, notifications and advertisements corresponding to the at least one application or the file in the secure folder and precluding access to the notifications and advertisements corresponding to the at least one application or the file until the primary user is detected accessing the electronic device. In one or more embodiments. Step 308 comprises hiding, by the one or more processors, all transaction messages originating from or received by the at least one application or the file.

Optional step 309 can comprise, when the at least one application or the file stored in the secure folder comprises the at least one application, managing, by the one or more processors, dual instances of the at least one application when the secondary user is a registered user of the at least one application. Embodiments of the disclosure contemplate that when one or more processors of an electronic device manage dual instances of an application, the processors create and maintain two separate versions of the same application. One version resides within the secure folder, accessible only to the primary user, while the other version remains outside the secure folder, accessible to non-primary users. This approach ensures that the data and settings associated with the application in the secure folder remain private and secure, while still allowing non-primary users to use the application without accessing the primary user's sensitive information.

Illustrating by example, in one or more embodiments the primary user can store the messaging application within the secure folder, ensuring that all personal conversations, contacts, and media files remain private and secure. The non-primary user can access a separate instance of the messaging application outside the secure folder, allowing them to use the application for their own conversations without accessing the primary user's data.

In another example, the primary user can keep the social media application within the secure folder, protecting their personal posts, messages, and account settings. The non-primary user can use a different instance of the social media application outside the secure folder, enabling them to log in with their own account and use the application independently.

In still another example, the primary user can store the banking application within the secure folder, safeguarding their financial information, transaction history, and account details. The non-primary user can access a separate instance of the banking application outside the secure folder, allowing them to use the application for their own banking needs without accessing the primary user's financial data.

The primary user can keep the email application within the secure folder, ensuring that all personal and work-related emails, contacts, and attachments remain confidential. The non-primary user can use a different instance of the email application outside the secure folder, enabling them to log in with their own email account and manage their emails independently.

By maintaining separate instances of applications, step 309 ensures that the primary user's sensitive data and settings remain protected within the secure folder. Non-primary users cannot access or view this information, reducing the risk of privacy breaches. Managing dual instances allows non-primary users to use the same applications without interfering with the primary user's data. This convenience is particularly beneficial in shared device scenarios, such as family members using the same smartphone or tablet.

By keeping the primary user's data separate and secure, the system minimizes the potential for conflicts and misunderstandings that may arise from non-primary users accidentally accessing or discovering sensitive information. Where included, step 309 provides a seamless user experience by allowing both primary and non-primary users to use their preferred applications without compromising security. Each user can access their own data and settings, ensuring a personalized and secure experience.

For devices used in professional or corporate environments, managing dual instances helps comply with security policies and regulations. Sensitive work-related applications and data can be kept secure within the secure folder, while non-primary users can still use the device for personal purposes. By managing dual instances of applications, the system effectively balances the need for privacy and security with the convenience of shared device usage, ensuring that sensitive information remains protected while providing a user-friendly experience for all users.

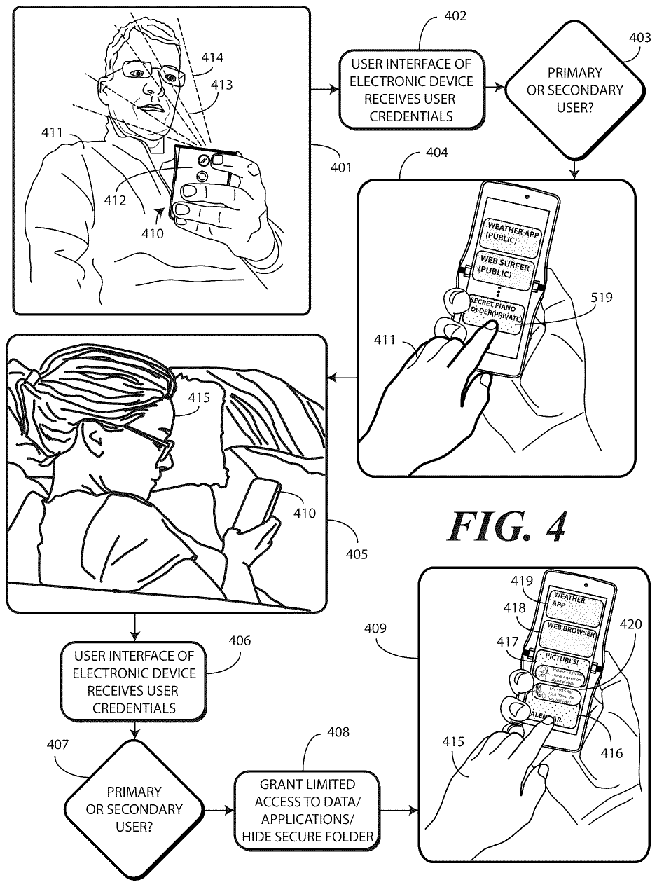

Turning now to FIG. 4, illustrated therein is another explanatory method in accordance with embodiments of the disclosure. Beginning at step 401, a user 411 named Buster is holding an electronic device 410.

In this explanatory example, Buster is secretly learning to play the piano to surprise his wife 415 on her birthday by performing Duke Ellington's “Prelude to a Kiss.” Buster has admired the rich, emotive quality of this ballad and believes that mastering the piece will be a gift for his wife, who has a deep appreciation for jazz music.

To achieve this, Buster has been diligently following Barry Harris's piano lessons, which are renowned for their focus on harmonic concepts that enhance the beauty of jazz ballads. Barry Harris's teachings emphasize the use of four scales of chords for harmony: the sixth diminished scale of chords, the minor sixth diminished scale of chords, the dominant seventh diminished scale of chords, and the dominant seventh flat five diminished scale of chords. These scales are particularly wonderful sounding as harmonic concepts because they provide a rich, textured backdrop that complements the melodic lines of a ballad.

The sixth diminished scale of chords, for instance, adds a lush, warm quality to the harmony, while the minor sixth diminished scale of chords introduces a subtle, melancholic undertone. The dominant seventh diminished scale of chords and the dominant seventh flat five diminished scale of chords offer tension and resolution, creating a dynamic interplay that is crucial for the expressive nature of jazz ballads.

In this illustrative embodiment, the electronic device 410 comprises a first device housing separated by a hinge from a second device housing 412. In one or more embodiments, the first device housing is pivotable about the hinge relative to the second device housing 412 from a closed position, shown at step 401, to an axially displaced open position, which is shown at steps 404 and 409.

At step 401, the Buster holding the electronic device 410 while the electronic device 410 is in the closed position. An exterior display is disposed on the exterior side of the first device housing is exposed and visible. An interior display, shown at step 404, is concealed when the electronic device 410 is in the closed position due to the fact that the interior surfaces of the first device housing and the second device housing 412, along which interior display is disposed, abut when the electronic device 410 is in the closed position.

At step 401, an imager of the electronic device 410 captures at least one image of the user 411. In this example, the imager of the electronic device 410 captures a plurality of images 413,414 of the user 411, which are received at step 402. Thereafter, one or more processors of the electronic device 410 compare, at decision 403, at least one image of the plurality of images 413,414 with one or more predefined reference images.

In one or more embodiments, at decision 403 the one or more processors perform a facial recognition process by determining, by comparing the at least one image of the plurality of images with the one or more predefined reference images, whether the at least one image sufficiently corresponds to the one or more predefined reference images.

Since Buster is a primary user of the electronic device 410, decision 403 leads to step 404. Given that Buster's wife 415 occasionally uses the electronic device 410, Buster needs to ensure that his piano lessons remain a secret. To this end, Buster has enabled a secure folder 519 on the device at step 404, where he stores all of Barry Harris's piano lessons, including at least one application helping Buster to learn to keep time. In this example, this secure folder 519 contains detailed tutorials on Barry's four scales of chords for harmony, allowing Buster to practice and refine his skills without the risk of his wife discovering his plans. By keeping these lessons hidden, Buster can continue to work on his surprise performance, confident that his efforts will remain a secret until the day.

It's a darned good thing too. At step 405 of FIG. 4, Buster's wife 415 has, without Buster's permission or knowledge, commandeered Buster's electronic device 410 to doom scroll medical advice about an ailment she perceives her pet terrier to have. During this unauthorized access, the system detects that the device is being operated by a non-primary user.

Advantageously for Buster, the one or more processors of the electronic device 410, leveraging methods at step 406 such as utilizing the camera during the lock screen or detecting grip patterns, identify that the user is not Buster, the primary user. In response to this detection determining that Buster's wife 415 is not Buster at decision 407, the system initiates a series of actions to protect the contents of the secure folder 519 at step 408.

Illustrating by example, in one or more embodiments the one or more processors conceal all contents and settings associated with the secure folder 519 by making them invisible and non-searchable on the device. As shown at step 409, the wife 415 cannot see any secure folder. Moreover, in one or more embodiments step 408 includes hiding all applications, files, notifications, and advertisements relevant to the secure folder. Additionally, in one or more embodiments step 408 hides all transaction messages originating from or received by the applications within the secure folder.

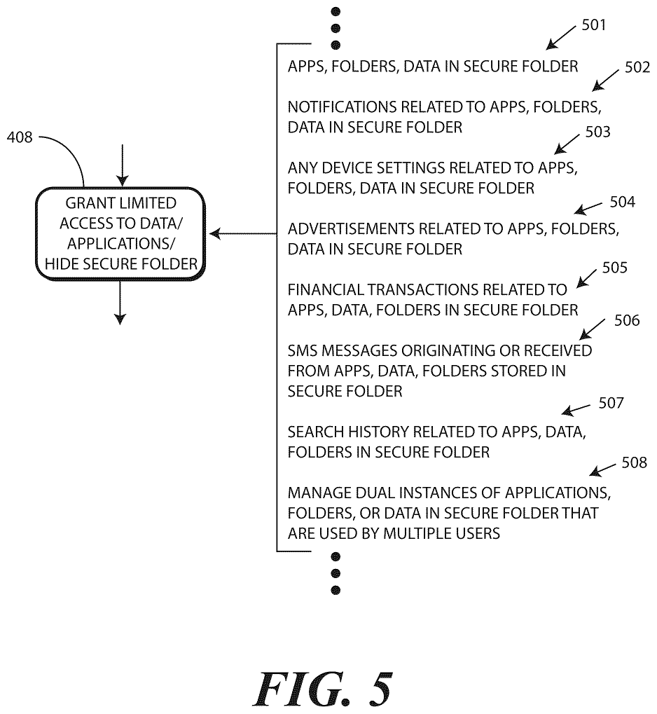

Step 408 can comprise other operations as well. Turning briefly to FIG. 5, illustrated therein are a few. Others will be obvious to those of ordinary skill in the art having the benefit of this disclosure.

In one or more embodiments, step 408 comprises, in response to a secondary user accessing the electronic device, both concealing, by the one or more processors, the secure folder and precluding notifications 502 generated by, or communications received by, the at least one application from being surfaced by a user interface of the electronic device. In one or more embodiments, this also comprises concealing, by the one or more processors, cross boundary data 501 spilling from the secure folder into public access application package kit data of the electronic device.

As used herein, cross boundary data refers to data that spills or leaks from a secure, restricted area (such as a secure folder) into a more accessible, public area of an electronic device. This data can include remnants or traces of applications, files, or settings that were initially stored within the secure folder but have somehow become visible or accessible outside of the secure folder.

For example, if a user moves an application into a secure folder, cross boundary data might include leftover data or metadata that remains in the device's public application package kit (APK) data, making detection of the presence of the application possible even though the application itself is supposed to be hidden within the secure folder. In one or more embodiments, the APK comprises data required to run and install applications stored in the secure folder. This can compromise the privacy and security of the information that the secure folder is meant to protect. In the context of the patent, the system aims to conceal this cross boundary data to ensure that no traces of the secure folder's contents are visible or accessible to non-primary users, thereby maintaining the confidentiality and security of the primary user's sensitive information.

In one or more embodiments, step 408 further comprises also concealing, by the one or more processors, all device settings 503 associated with the at least one application in response to the secondary user accessing the electronic device. Step 408 can further comprise also concealing, by the one or more processors, operational code, assets, and resources associated with the at least one application.

Illustrating by example, step 408 can comprise also concealing, by the one or more processors, advertisements 504 received by a communication device of the electronic device that are related to the at least one application. Step 408 can comprise concealing short message service (SMS) communications 506. Financial transactions 505 related to applications stored in the secure folder can be precluded from presentation as well. Search history 507 can be blocked from visibility in a similar manner.

In one or more embodiments, step 408 comprises, when the at least one application is configured for use by multiple users, maintaining, by the one or more processors, dual instances 508 of the application as previously described. In one or more embodiments, the dual instances 508 of the application comprise a first instance of the application utilizing first data associated with the secondary user and omitting usage of second data associated with the primary user and a second instance of the application utilizing the first data and the second data.

Turning now back to FIG. 4, in one or more embodiments step 408 comprises precluding visibility of the secure folder at the user interface of the electronic device. By doing so, the system ensures that Buster's wife 415 cannot access or become aware of the secure folder's existence or the secure folder's contents, thereby maintaining the privacy and security of Buster's sensitive information, as shown at step 409. Instead, she sees a weather application 419, a web browser 418, a photos application 417, and notifications 420 generated by the photos application 417. Accordingly, she is none the wiser about Buster's learning to play like Barry Harris. Indeed, the secure folder 519 has been replaced by a calendar application 416.

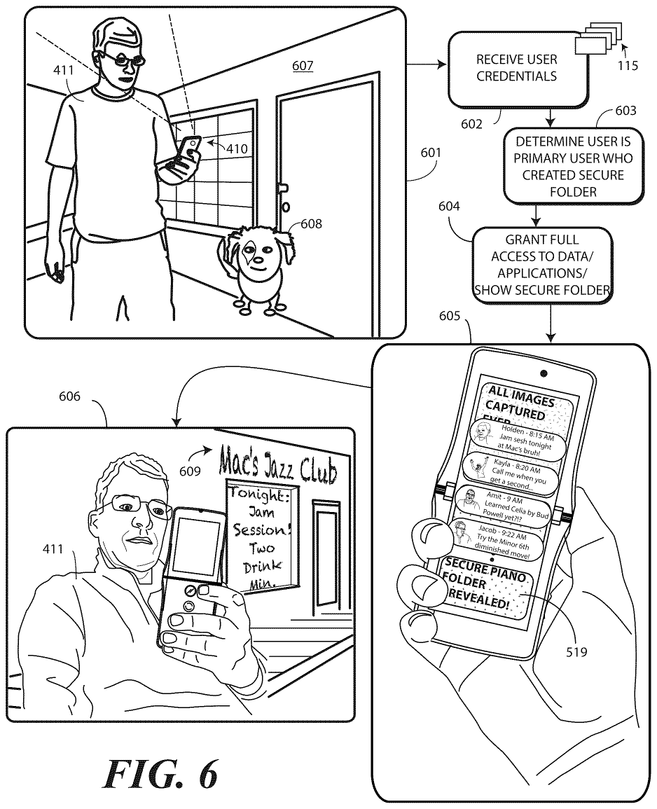

Turning now to FIG. 6, the delicate ballet between Buster and his wife (415) continues. At step 601 of FIG. 6, Buster, our friendly user 411, has once again gained control of his electronic device 410. Buster is in his music studio 607 with his trusty dog 608, Henry.

In this environment, Buster can practice Barry's single note lines, which include running scales up and down, running them in thirds, running them in triads, running them in chords, practicing pivots, and practicing the three important arpeggios on the tonic, fifth, and seventh of each chord. Buster utilizes his electronic device 410 to access detailed tutorials and practice sessions stored within the secure folder.

These tutorials guide Buster through the intricate techniques of running scales in various forms, ensuring that he achieves the fluidity and precision required for each exercise. By running scales up and down, Buster develops finger strength and dexterity, while running scales in thirds and triads enhances his understanding of harmonic relationships. Additionally, Buster practices running scales in chords, which helps him internalize the chordal structures and their applications in different musical contexts. The practice of pivots, which involves shifting between different positions on the keyboard, further refines Buster's agility and accuracy. Buster focuses on the three arpeggios on the tonic, fifth, and seventh of each chord, which are necessary for creating smooth and expressive melodic lines. Throughout his practice sessions, Buster's electronic device 410 remains secure, ensuring that his progress and personal notes are protected from unauthorized access. This allows Buster to concentrate fully on his musical development, confident that his efforts are safeguarded within the secure folder.

To see the secured folder, Buster is authenticated at step 602 against one or more predefined reference files. Step 603 determines that the primary user who enabled the secure folder 519 is handling the electronic device 410. Step 604 then terminates the concealing, by the one or more processors, the secure folder 519 and the precluding notifications generated by, or communications received by, the at least one application from being surfaced by a user interface of the electronic device 410. Accordingly, at step 605, the secure folder 519 is revealed.

At step 606 of FIG. 6, Buster stands outside Mac's Jazz Club 609, eagerly anticipating the evening's events. Buster has cleverly convinced his wife that they will be attending a performance by the Piano Guys, a group she adores.

However, Buster has orchestrated a different plan for the night. He intends to take the stage during the jam session and surprise his wife with a heartfelt rendition of “Prelude to a Kiss,” a piece he has been secretly practicing for months. As the evening progresses, the atmosphere inside Mac's Jazz Club becomes electric with anticipation.

The audience, a mix of jazz enthusiasts and casual listeners, eagerly awaits the next performer. When Buster's name is announced, his wife looks puzzled but intrigued. Buster takes his place at the piano, his heart racing with excitement and a touch of nervousness.

He begins to play, his fingers dancing gracefully over the keyboard, bringing Barry Harris's harmonic concepts to life. The audience listens intently, captivated by the emotive quality of Buster's performance.

As he reaches the climax of the piece, Buster skillfully drops a diminished chord right in the middle of a true minor chord, creating a moment of tension and resolution that resonates deeply with the listeners. The harmonic twist adds a layer of complexity and beauty to the performance, showcasing Buster's dedication and musical growth.

The room erupts in applause as Buster finishes the song, the audience moved by the heartfelt performance. Buster's wife, overwhelmed with emotion, rushes to the stage, her eyes filled with tears of joy and pride. The surprise and the music have created an unforgettable moment, one that will be cherished by both Buster and his wife for years to come. The success of the evening is a testament to Buster's hard work and the power of music to bring people together, as well as the success offered by embodiments of the disclosure, in response to determining that the electronic device is being accessed by a non-primary user back in FIG. 4, concealing, by the one or more processors, all contents and settings associated with the secure folder by making the contents and settings invisible and unsearchable on the electronic device, hiding, by the one or more processors, all notifications and advertisements corresponding to the at least one application or the file, and hiding, by the one or more processors, all transaction messages originating from or received by the at least one application or the file.

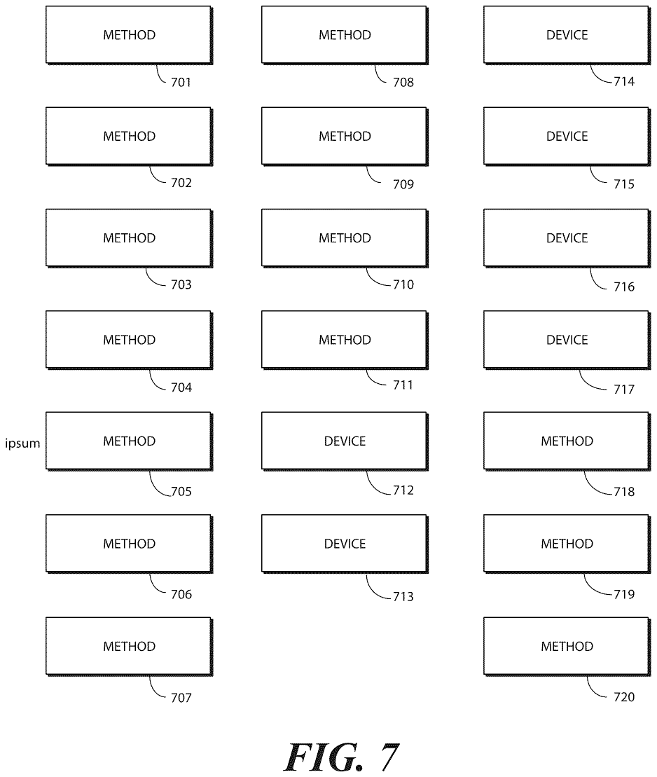

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises determining, by one or more processors of the electronic device, that a secure folder has been enabled on the electronic device by a primary user. At 701, the method comprises determining that at least one application has been stored in the secure folder by the primary user. At 701, the method comprises, in response to a secondary user accessing the electronic device, both concealing, by the one or more processors, the secure folder and precluding notifications generated by, or communications received by, the at least one application from being surfaced by a user interface of the electronic device.

At 702, the method of 701 further comprises concealing, by the one or more processors, cross boundary data spilling from the secure folder into public access application package kit data of the electronic device. At 703, the method of 701 further comprises also concealing, by the one or more processors, an application package kit associated with the at least one application. At 704, the application package kit of 703 comprises data required to install and run the at least one application.

At 705, the method of 703 further comprises also concealing, by the one or more processors, all device settings associated with the at least one application in response to the secondary user accessing the electronic device. At 706, the method of 703 further comprises also concealing, by the one or more processors, operational code, assets, and resources associated with the at least one application.

At 707, the method of 701 further comprises also concealing, by the one or more processors, advertisements received by a communication device of the electronic device that are related to the at least one application. At 708, the communications of 701 comprise short message service (SMS) communications.

At 709, the concealing the secure folder of 701 comprises precluding visibility of the secure folder at the user interface of the electronic device. At 710, the method of 701 further comprises, when the at least one application is configured for use by multiple users, maintaining, by the one or more processors, dual instances of the application. At 711, the dual instances of the application of 710 comprise a first instance of the application utilizing first data associated with the secondary user and omitting usage of second data associated with the primary user and a second instance of the application utilizing the first data and the second data.

At 712, an electronic device comprises a user interface, a communication device, and one or more processors operable with the user interface and the communication device. At 712, the one or more processors are configured to, in response to a primary user having enabled a secure folder prior to a secondary user accessing the electronic device, conceal the secure folder and preclude notifications generated by, or communications received by, at least one application residing in the secure folder from being surfaced at the user interface of the electronic device while being used by the secondary user.

At 713, the one or more processors of 712 are further configured to hide all transaction messages originating from or received by the at least one application residing in the secure folder. At 714, the one or more processors o f713 are further configured to manage dual instances of the at least one application when the secondary user has a user account at the at least one application, with at least one instance of the at least one application being hidden and unsearchable by the secondary user.

At 715, the electronic device of 714 comprises one or more sensors. At 715, the one or more processors are further configured to, in response to the one or more sensors detecting an authorized user of the electronic device holding the electronic device, reveal the secure folder on the user interface.

At 716, a method in an electronic device comprises determining, by one or more processors of the electronic device, that a secure folder has been enabled on the electronic device by a primary user. At 716, the method comprises determining, by the one or more processors, that at least one application or file has been added to the secure folder by the primary user.

At 716, the method comprises determining, by the one or more processors, the electronic device is being accessed by a non-primary user. At 716, in response to determining that the electronic device is being accessed by a non-primary user, the method comprises concealing, by the one or more processors, all contents and settings associated with the secure folder by making the contents and settings invisible and unsearchable on the electronic device, hiding, by the one or more processors, all notifications and advertisements corresponding to the at least one application or the file, and hiding, by the one or more processors, all transaction messages originating from or received by the at least one application or the file.

At 717, the at least one application of 716 or the file comprises the at least one application. AT 717, the method further comprises managing, by the one or more processors, dual instances of the at least one application when the secondary user is a registered user of the at least one application.

At 718, the method of 717 further comprises hiding, by the one or more processors, all device settings associated with the at least one application in response to the secondary user accessing the electronic device. At 719, the method of 718 further comprises concealing, by the one or more processors, cross boundary data spilling from the secure folder into public access application package kit data of the electronic device.

At 720, the method of 716 further comprises storing, by the one or more processors, notifications and advertisements corresponding to the at least one application or the file in the secure folder. At 720, the method comprises precluding access to the notifications and advertisements corresponding to the at least one application or the file until the primary user is detected accessing the electronic device.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in various embodiments the electronic device comprises a user interface, a communication device, and one or more processors operable with the user interface and the communication device. In one embodiment, the user interface includes a touch-sensitive display, such as an AMOLED or LCD screen, which allows users to interact with the device through touch inputs. The communication device may support multiple communication protocols, including Wi-Fi, Bluetooth, and cellular networks, enabling the device to connect to the internet and other devices seamlessly.

The one or more processors can include a combination of an application processor and auxiliary processors, which may be microprocessors, ASICs, or programmable logic devices, to handle various computational tasks efficiently. In another embodiment, the electronic device may incorporate advanced biometric sensors, such as facial recognition cameras or fingerprint scanners, to enhance security and user authentication processes.

Additionally, the device may feature environmental sensors, like accelerometers, gyroscopes, and proximity sensors, to detect user interactions and contextual information, further improving the user experience. The processors are configured to conceal the secure folder and preclude notifications and communications from being surfaced at the user interface when a secondary user accesses the device, ensuring the privacy and security of the primary user's data.

In yet another embodiment, the device may include a context engine that leverages artificial intelligence to analyze sensor data and user behavior, dynamically adjusting security measures based on the detected context. This adaptability allows the device to provide robust security while maintaining usability across different scenarios and user interactions.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
determining, by one or more processors of the electronic device, that a secure folder has been enabled on the electronic device by a primary user;
determining that at least one application has been stored in the secure folder by the primary user; and
in response to a secondary user accessing the electronic device, both concealing, by the one or more processors, the secure folder and precluding notifications generated by, or communications received by, the at least one application from being surfaced by a user interface of the electronic device.

2. The method of claim 1, further comprising concealing, by the one or more processors, cross boundary data spilling from the secure folder into public access application package kit data of the electronic device.

3. The method of claim 1, further comprising also concealing, by the one or more processors, an application package kit associated with the at least one application.

4. The method of claim 3, wherein the application package kit comprises data required to install and run the at least one application.

5. The method of claim 3, further comprising also concealing, by the one or more processors, all device settings associated with the at least one application in response to the secondary user accessing the electronic device.

6. The method of claim 3, further comprising also concealing, by the one or more processors, operational code, assets, and resources associated with the at least one application.

7. The method of claim 1, further comprising also concealing, by the one or more processors, advertisements received by a communication device of the electronic device that are related to the at least one application.

8. The method of claim 1, wherein the communications comprise short message service (SECOND MAJOR SURFACE) communications.

9. The method of claim 1, wherein the concealing the secure folder comprises precluding visibility of the secure folder at the user interface of the electronic device.

10. The method of claim 1, further comprising, when the at least one application is configured for use by multiple users, maintaining, by the one or more processors, dual instances of the application.

11. The method of claim 10, wherein the dual instances of the application comprise a first instance of the application utilizing first data associated with the secondary user and omitting usage of second data associated with the primary user and a second instance of the application utilizing the first data and the second data.

12. An electronic device, comprising:
a user interface;
a communication device; and
one or more processors operable with the user interface and the communication device;
wherein the one or more processors are configured to, in response to a primary user having enabled a secure folder prior to a secondary user accessing the electronic device, conceal the secure folder and preclude notifications generated by, or communications received by, at least one application residing in the secure folder from being surfaced at the user interface of the electronic device while being used by the secondary user.

13. The electronic device of claim 12, wherein the one or more processors are further configured to hide all transaction messages originating from or received by the at least one application residing in the secure folder.

14. The electronic device of claim 13, wherein the one or more processors are further configured to manage dual instances of the at least one application when the secondary user has a user account at the at least one application, with at least one instance of the at least one application being hidden and unsearchable by the secondary user.

15. The electronic device of claim 14, further comprise one or more sensors, wherein the one or more processors are further configured to, in response to the one or more sensors detecting an authorized user of the electronic device holding the electronic device, reveal the secure folder on the user interface.

16. A method in an electronic device, the method comprising:
determining, by one or more processors of the electronic device, that a secure folder has been enabled on the electronic device by a primary user;
determining, by the one or more processors, that at least one application or file has been added to the secure folder by the primary user;
determining, by the one or more processors, the electronic device is being accessed by a non-primary user;
in response to determining that the electronic device is being accessed by a non-primary user:
concealing, by the one or more processors, all contents and settings associated with the secure folder by making the contents and settings invisible and unsearchable on the electronic device;
hiding, by the one or more processors, all notifications and advertisements corresponding to the at least one application or the file; and
hiding, by the one or more processors, all transaction messages originating from or received by the at least one application or the file.

17. The method of claim 16, wherein the at least one application or the file comprises the at least one application, further comprising managing, by the one or more processors, dual instances of the at least one application when the non-primary user is a registered user of the at least one application.

18. The method of claim 17, further comprising, further comprising hiding, by the one or more processors, all device settings associated with the at least one application in response to the non-primary user accessing the electronic device.

19. The method of claim 18, further comprising concealing, by the one or more processors, cross boundary data spilling from the secure folder into public access application package kit data of the electronic device.

20. The method of claim 16, further comprising storing, by the one or more processors, notifications and advertisements corresponding to the at least one application or the file in the secure folder and precluding access to the notifications and advertisements corresponding to the at least one application or the file until the primary user is detected accessing the electronic device.
